(19) United States
(12) Patent Application Publication
(10) Pub. No.: US 2003/0147308 A1
(43) Pub. Date: Aug. 7, 2003

(54) World clock

(76) Inventor: John Hincks Duke, Providence, RI (US)

Correspondence Address: John H. Duke, 11 Elton St., Providence, RI, 02906, US

(21) Appl. No.: 10/356,117

(22) Filed: Jan. 31, 2003

Related U.S. Application Data
(60) Provisional application No. 60/353,729, filed on Jan. 31, 2002.

(51) Int. Cl. G04B 19/22

(52) U.S. Cl. 368/21

(57) ABSTRACT

The clock shows time as a function of the earth's rotation in a way that distinguishes universal time from local solar time, according to where the user resides within his or her time zone. Time is indicated by movement a marker at the user's location on a rotating polar projection map of the earth.

### BRIEF SUMMARY

The clock shows time as a function of the earth's rotation in a way that distinguishes universal time from local solar time, according to where the user resides within his or her time zone. Time is indicated by movement a marker at the user's location on a rotating polar projection map of the earth.

### BRIEF DECRIPTION OF DRAWINGS

FIG. 1 Front perspective view;

FIG. 2 Rear perspective view;

FIG. 3 Exploded view;

FIG. 4 Detail view of longitude offset adjustment means;

FIG. 5 View of computer software based embodiment;

FIG. 6 User data input for software based embodiment;

FIG. 7 Logic diagram for software based embodiment.

### DESCRIPTION

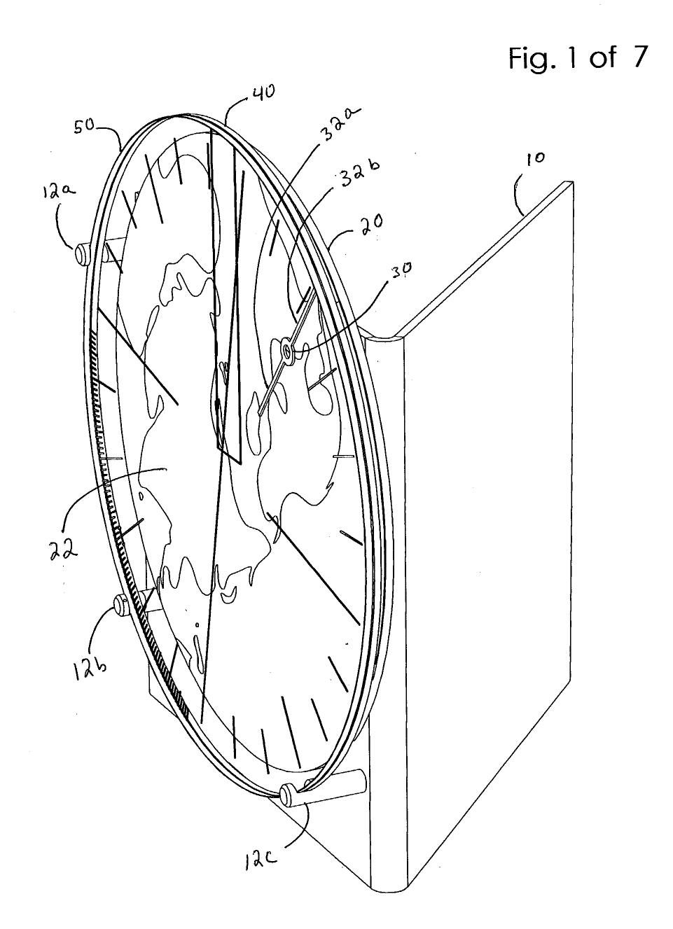

In a front view of the clock FIG. 1 shows a base 10 which rotatably supports a disc 20 by a conventional shaft not shown. Integral to the front facing surface of disc 20 is a map graphic 22 depicting a north polar or south polar view of earth in alternate versions of the clock. In the preferred embodiment map graphic 22 is a Lambert azimuthal equal area polar projection. A user positionable locator 30 is movably mounted upon the surface of map graphic 22. In the preferred embodiment locator 30 incorporates a magnetic property and disc 20 incorporates a magnetic receptive property. Integral to locator 30 are a pair of meridian portions 32a and 32b. Projecting from the front facing surface of base 10 are a series of supports 12a, 12b, and 12c which collectively rotatably support a substantially round noon lens 40 and a substantially round hour lens 50.

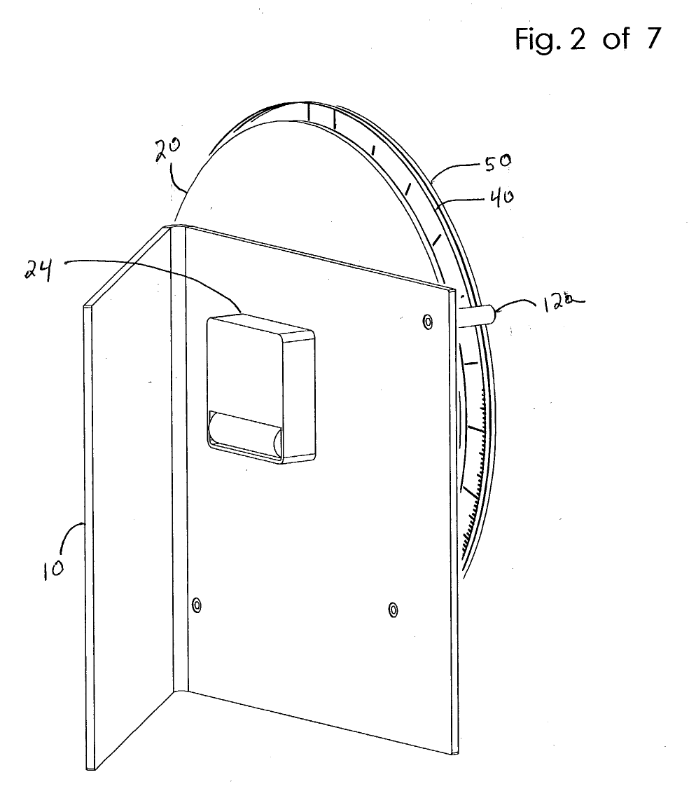

FIG. 2 is a rear view showing a conventional electrical clock movement 24 which powers rotation of disc 20 via the conventional shaft not shown. In the north version clock movement 24 turns counterclockwise and in the south version it turns clockwise.

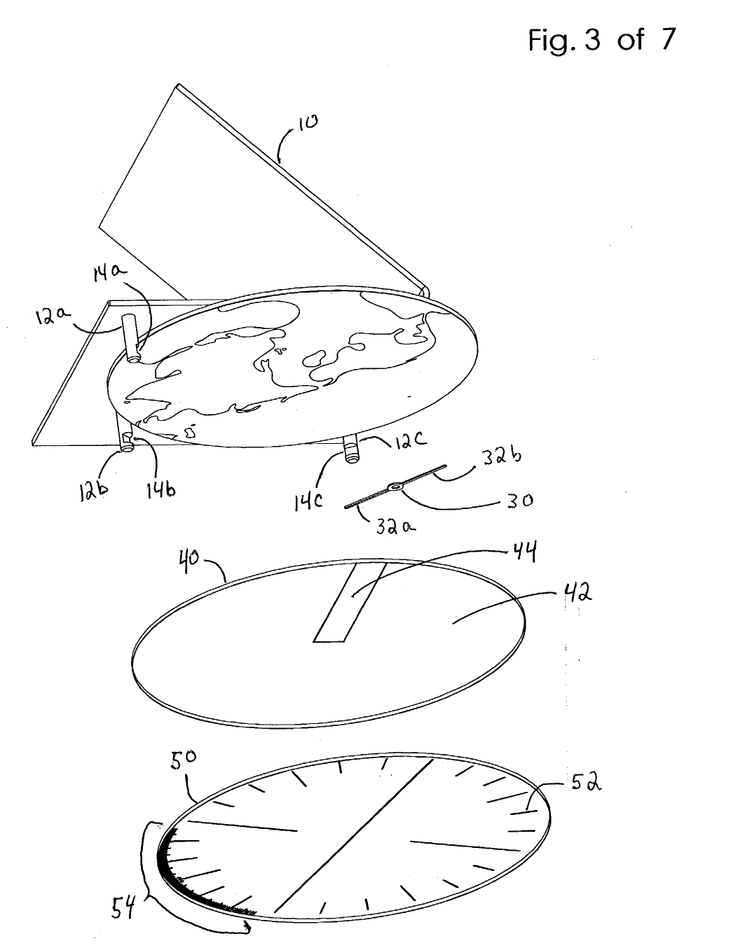

FIG. 3 shows an exploded view of the clock. Here visible is a series of notch features 14a, 14b, and 14c respectively integral to supports 12a, 12b, and 12c which retain noon lens 40 and hour lens 50 when unexploded. Integral to noon lens 40 is a translucent area 42 and a substantially transparent solar noon area 44. Area 44 is an elongated substantially radial shape. Hour lens 50 is substantially transparent and bears a group of opaque hour marks 52 (indicated by example) representing universal time hours. A circumferential portion of hour lens 50 further bears a group of opaque longitude offset marks 54 substantially in the form of a radial scale. Longitude offset mark group 54 overlaps hour mark group 52.

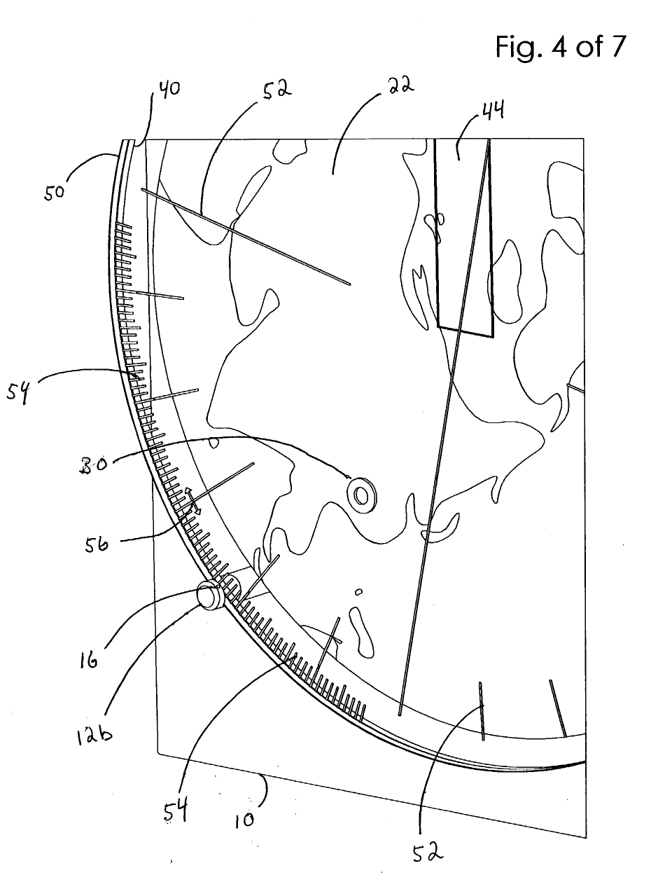

FIG. 4 is a detail view showing a datum mark 16 integral to support 12b. Hour lens 50 further bears a middle of scale mark 56 designating a central reference point in longitude offset mark group 54. Here locator 30 is shown without meridian portions 32a and 32b. Support 12b is located on base 10 so that when datum mark 16 aligns with middle of scale mark 56 the midday mark within hour mark group 52 substantially aligns with the longitudinal axis of solar noon area 44.

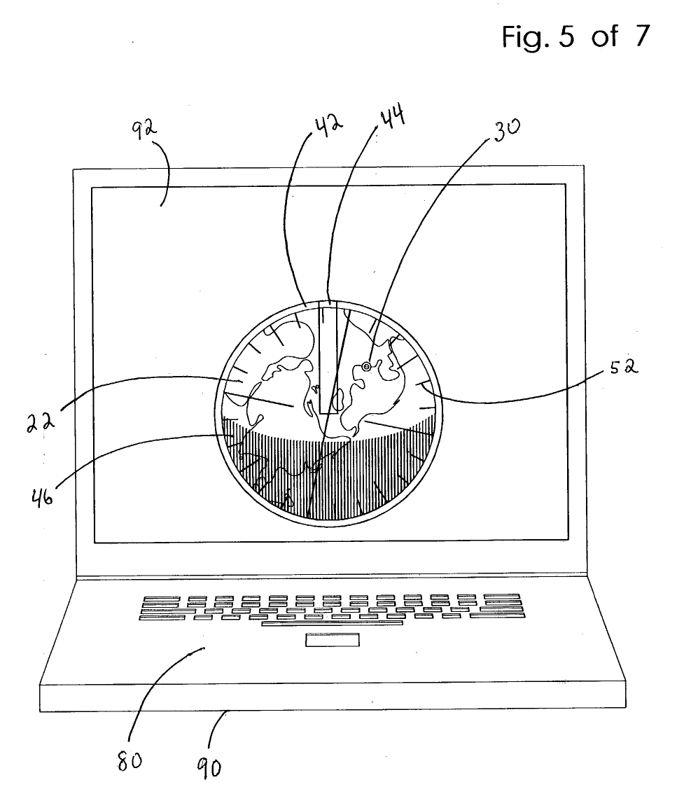

FIG. 5 depicts the graphic output of a computer program 80 installed on a host computer 90 and displayed on a display device 92. The function of program 80 is an alternative embodiment of the invention. The graphic output of program 80 employs conventional computer display transparency effects to simulate a user's view of map graphic 22 and locator 30 as it is seen through hour lens 50 and noon lens 40, except longitude offset mark group 54 and middle of scale mark 56 are not displayed. Further incorporated in the graphic output of program 80 is a relatively more opaque night indicating area 46, the axis of symmetry of which is substantially co-linear with the longitudinal axis of solar noon area 44. Program 80 calculates and displays known seasonal changes in the shape of night indicating area 46 with reference to the current date value in the memory of host computer 90. Also with reference to that date value program 80 calculates and displays a variation due to the Equation of Time in the angle of hour mark group 52 with respect to the substantially vertical solar noon area 44.

Program 80 provides conventional data input means whereby the user enters his or her location on earth by selecting a city from a conventional menu or by direct entry of latitude and longitude coordinates. This is analogous to the user physically placing locator 30 on map graphic 22. Program 80 further provides a means to optionally display numeric local time values for the user at locator 30 and for other user designated locations.

Program 80 further provides a means to move its graphic output within display device 92 so that it may serve as a ‘screen saver’. In addition to the graphic output turning on or off automatically as a screen saver, a conventional keyboard or display based switch means may serve to turn it on or off. If turned on in this way it remains on in a stationary position, and conventional means are provided to re-size and locate the image on display device 92 so it may run concurrently adjacent to other computer applications.

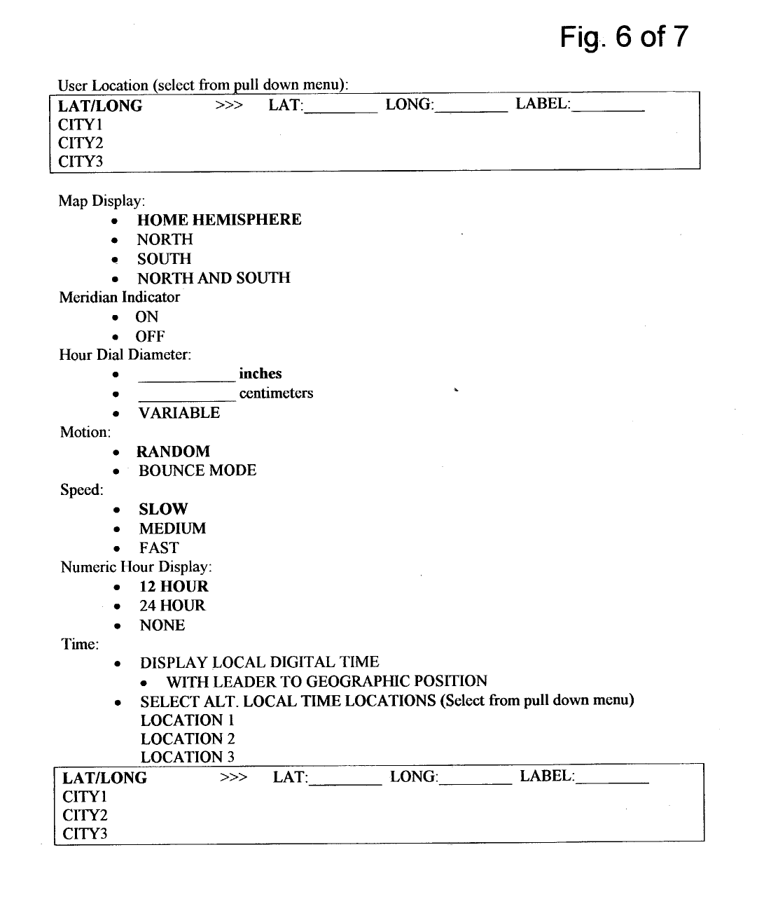

FIG. 6 shows the user input used in the preferred embodiment to initiate program 80. These inputs include user location, map hemisphere designation, meridian indicator on/off, clock image diameter, screen saver motion mode, speed, hour mark labels, user local time display, and alternate location time display. In the preferred embodiment this is a conventional control panel input procedure. The bounce motion mode provides an illusion that the program's graphic output follows a kinetic trajectory following apparent contact with the boundaries of display 92. The other available options for the above inputs are self explanatory to one skilled in the art.

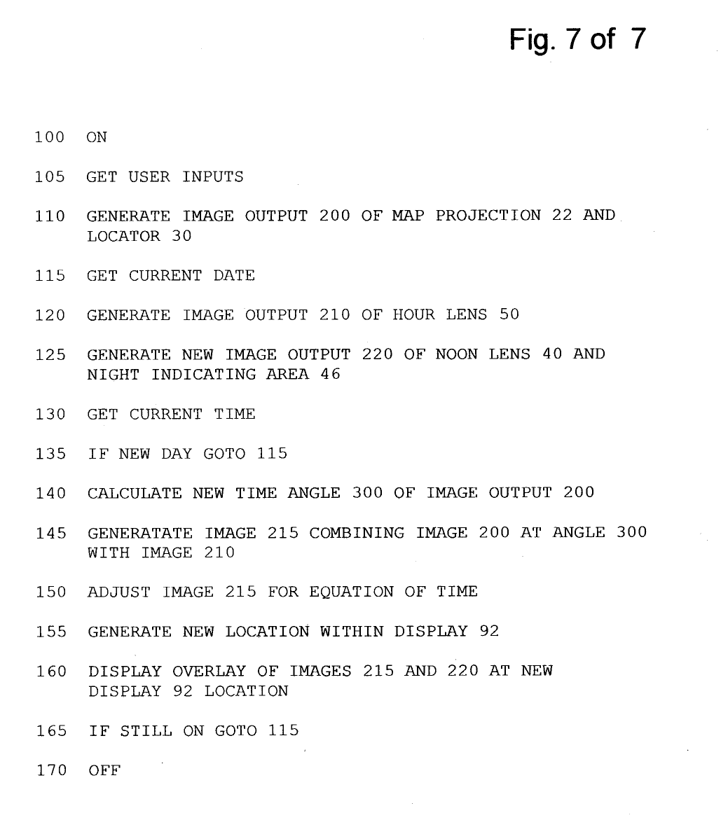

FIG. 7 is a logic sequence used in the preferred embodiment to update program 80's graphic output with the passage of time. In a step 100 program 80 executes in response to either user action or screen saver timeout. A step 105 retrieves above user input options. A step 110 draws an image 200 depicting map graphic 22 and locator 30. A step 115 retrieves the current date from host computer 90's memory. A step 120 draws an image 210 depicting hour lens 50 at a longitude offset angle based on the user's location. A step 125 draws an image 220 depicting noon lens 40 and night indicating area 46 based on current date. A step 130 retrieves the current time from host computer 90's memory. In a step 135 program 80 goes to step 115 if time exceeds twenty-four hours. A step 140 calculates a display angle 300 for image 200 based on current time. A step 145 draws an image 215 combining image 200 at angle 300 with image 210. A step 150 rotates image 215 according to current equation of time variation. A step 155 generates a new display position in display 92 if in screen saver mode. A step 160 displays an overlay of images 215 and 220. In a step 165 program 80 goes to step 115 if still on. A step 170 terminates program 80. The specific computer operating instructions used by program 80 to do so are known to those skilled in the art.

Alternative Embodiment

An alternative embodiment of the invention that will be apparent to one skilled in the art provides a spherical graphic representation of earth analogous to map graphic 22 which turns upon a base substantially concentrically within a spherical hour indicating cover analogous to hour lens 50 and a spherical noon indicating cover analogous to noon lens 40. Further provision may be made to incorporate a night/day differentiating means in said noon indicating cover and a means to vary the inclination of said spherical graphic representation of earth and said spherical hour indicating cover with respect to said noon indicating cover. Further provision may be made to rotate said spherical graphic representation together with said spherical hour indicating cover according to the Equation of Time.

Operation

The user first places locator 30 at his or her position on map graphic 22. Next the user rotates noon lens 40 so that solar noon area 44 points in a substantially upward vertical direction. In a third step the user rotates hour lens 50 so that middle of scale mark 56 aligns with datum mark 16. Next the user rotates hour lens 50 by an offset angle measured on longitude offset mark group 54 substantially equal to the angular difference between the user's own longitude and a reference longitude of his or her time zone. The reference longitude of a time zone is fifteen degrees times the hour difference of that time zone from Greenwich Mean Time, where hours before GMT yield west longitude and hours after GMT yield east longitude. The direction of said offset angle rotation is such that, for example in the northern hemisphere version of the clock, if the user's longitude is west of the reference longitude of his or her time zone, then said offset rotation of noon lens 40 is clockwise.

If a daylight savings time convention is then in effect the user next rotates hour lens fifteen degrees clockwise for the north version of the clock and counterclockwise for the south version.

Lastly, the user rotates disc 20 so that locator 30 aligns with the position within hour mark group 52 which corresponds to his of here local time. In the preferred embodiment disc 20 is coupled to shaft from clock movement 24 via a conventional slip clutch not shown so that the user may rotate disc 20 directly by hand.

When clock movement 24 is running, in the above northern hemisphere example in which the user is west of his or her reference longitude, locator 30 turns counterclockwise on map graphic 22. It passes behind the mark representing 12:00 AM within hour mark group 52 prior to passing behind solar noon area 44, indicating mean solar noon occurring after 12:00 AM.

Benefit

The clock provides its user a means of relating his or her subjective awareness of the passage of time to the natural solar day to. Also, by displaying the user's location on a rotating surface it provides a geographic perspective distinct from that which derives from flat wall maps.

I claim:

1. A timekeeping device including
a base supporting a means to rotate a graphic representation of the earth about a polar axis approximately once a day,
a user positionable means of indicating a location on said graphic representation,
a first means of indicating a first direction with respect to said base representing the direction towards the sun from the center of said graphic representation, and
a user adjustable second means of indicating a second direction from the center of said graphic representation.

2. The timekeeping device of claim 1 in which the angular relation about said polar axis between said second direction and said first direction is substantially equivalent to the angular relation about said polar axis between the longitude of said location and a reference longitude within the time zone in which said location falls, where said reference longitude is fifteen degrees times the hour difference from GMT of said time zone.

3. The timekeeping device of claim 2 in which said second direction indicating means incorporates a first radial scale substantially concentric with said polar axis which represent temporal divisions of the day.

4. The timekeeping device of claim 3 further incorporating a second radial scale providing the user a measure of the angle about said polar axis between said second and first directions.

5. A computer program which generates an image based on user inputs which is substantially equivalent an image of the timekeeping device of claim 2.
